(19) United States
(12) Patent Application Publication
(10) Pub. No.: US 2012/0132876 A1
(43) Pub. Date: May 31, 2012

(54) GUARD SURFACE STRUCTURE

(75) Inventors: Youichi Nishita, Niigata (JP); Toshimitsu Nomura, Niigata (JP); Shouichi Inoue, Niigata (JP); Tomohiro Fujii, Niigata (JP)

(73) Assignee: Protec Engineering, Inc., Niigata (JP)

(21) Appl. No.: 13/060,307

(22) PCT Filed: Jan. 31, 2011
(86) PCT No.: PCT/JP11/51901

§ 371 Date: Feb. 23, 2011

(30) Foreign Application Priority Data
Nov. 30, 2010 (JP) 2010-267700

(51) Int. Cl. E01F 7/04; F16F 9/30

(52) U.S. Cl. 256/12.5; 188/268

(57) ABSTRACT

There is provided a guard surface structure excellent in shock-absorbing effect due to an unprecedented structure formed by combining a deformable supporting surface and shock-absorbing members. A guard surface structure comprises a net body 4 supported by support posts 3, such net body 4 comprising a wire mesh 11, and being deformable and provided with shock-absorbing bags 21 filled with sands. By combining the deformable net body 4 and the shock-absorbing bags 21, a force of impact due to rockfall or the like can be effectively absorbed due to deformation behaviors of the shock-absorbing bags 21 and the net body 4. In this case, sands inside the shock-absorbing bags 21 are caused to move when subjected to the force of impact, thereby allowing the shock-absorbing bags 21 to deform and thus absorb the force of impact. Further, the net body 4 deforms after the force of impact has been first applied to the shock-absorbing bags 21, thus allowing the net body 4 to deform less. Furthermore, since the net body 4 is provided between the support posts 3, 3 . . . , a shock-absorbing effect of a guard fence can be improved.

### TECHNICAL FIELD

The present invention relates to a guard surface structure used for protection from rockfall, mudslide, avalanche or the like.

### BACKGROUND ART

Conventionally, as a guard surface structure of a guard body of this type, there have been disclosed a rock shed mainly composed of support posts, beam materials, and a roof material, and having earths and sands laid on an uppermost layer of a roof portion thereof (e.g., see patent document 1). Further, as another rock shed guard structure for preventing damages due to rockfall or the like, there has been provided a guard surface structure in which a plurality of layers of panel-shaped styrene foam blocks are stacked on an upper surface of a tilted roof portion, a corrosion-resistant net is laid on the panel-shaped styrene foam blocks stacked, and lightweight concrete or mortar is further casted on the corrosion-resistant net (e.g., see patent document 2). Furthermore, there has been provided a guard fence in which a wall material comprising a plurality of H section steels is horizontally disposed in front of fence posts installed at intervals in a traverse direction of a slope, and shock-absorbing members such as rubber tiers or the like are provided on a mountain side of the wall material (e.g., see patent document 3). Furthermore, there has been provided a guard structure comprising: a guard surface provided along a mountain and at least partially covering a road or a railroad located along the mountain; and supporting bodies supporting the guard surface, such guard structure further comprising a cushion material made of chips obtained by crushing old tires (e.g., see patent document 4). Furthermore, there has been provided a shock-absorbing fence in which posts are provided at predetermined intervals, a horizontal rope member is provided between the posts in a horizontally slidable manner with both ends thereof fixed, and a wire net hung on the horizontal rope member serves to fill a space between adjacent posts. In addition, this shock-absorbing fence is provided with a shock-absorbing portion comprising: an extra length portion formed by curling back the horizontal rope member at a midsection thereof; and a clamping instrument for holding the extra length portion with a predetermined force. Once a tension force as large as or larger than a set tension force has been applied to the horizontal rope member, the extra length portion will extend with the horizontal rope member exhibiting a constant friction force, thereby absorbing the tension force (e.g., see patent document 5).

Further, the same applicant has proposed a guard fence in which rope members are partially and convexly deflected by a predetermined amount by means of deflection causing members, thereby reducing a tension force applied to posts by the rope members, and thus reducing forces applied to the posts when subjected to a force of impact due to rock fall or snow pressure (e.g., see patent document 6).

### REFERENCES

Patent document 1: Japanese unexamined patent application publication No. H6-173221

Patent document 2: Japanese unexamined utility model application publication No. S54-3826

Patent document 3: Japanese unexamined patent application publication No. H1-214830

Patent document 4: Japanese unexamined patent application publication No. H9-221720

Patent document 5: Japanese unexamined patent application publication No. H9-184116

Patent document 6: Japanese unexamined patent application publication No. 2009-102855

### DISCLOSURE OF THE INVENTION

### Problem to be solved by the invention

The rock shed according to the patent document 1 absorbs a force of impact due to rockfall or the like by means of earths and sands. According to the patent document 2, the force of impact due to rockfall or the like is absorbed by styrene foam blocks. According to the patent document 3, the force of impact due to rockfall or the like is absorbed by rubber tires. According to the patent document 3, the force of impact due to rockfall is absorbed by chips obtained by crushing old tires. In a guard surface structure in which shock-absorbing materials such as earth and sand, styrene foam blocks, rubber tires, rubber chips or the like are provided on a roof and a wall member that are made of hard materials, a force of impact is absorbed due to the plastic deformation of such shock-absorbing materials, and therefore, an impact-absorbing effect cannot be effectively improved.

In contrast, the shock-absorbing fence disclosed in the patent document 5 comprises a shock-absorbing instrument (shock-absorbing portion) allowing the extra length portion to extend with the horizontal rope members exhibiting the constant friction force and thus absorb the force of impact, when the tension force as large as or larger than the set tension force has been applied to the horizontal rope members.

However, a guard surface structure comprising a shock absorbing instrument undergoes deformation by a large amount when absorbing a force of impact, thus making it difficult to install such guard surface structure, particularly when an area of an installation location thereof is limited. Further, since the shock-absorbing instrument has no restoring force, maintenance thereof needs to be mindfully conducted after the rope members have finished sliding.

Therefore, it is an object of the present invention to provide a guard surface structure excellent in shock-absorbing effect due to an unprecedented structure formed by combining a deformable supporting surface and shock-absorbing members.

### Means for Solving the Problem

(1) The present invention is a guard surface structure comprising a guard surface supported by supporting bodies, in which the guard surface is deformable and shock-absorbing members are arranged on a mountain side of the guard surface.

According to the aforementioned structure, by combining the deformable guard surface and the shock-absorbing members, a force of impact due to rockfall or the like can be effectively absorbed due to deformation behaviors of the shock-absorbing members and the guard surface. In this case, the guard surface is caused to deform after the force of impact has been applied to the shock-absorbing members, thereby allowing the guard surface to deform less.

Further, the present invention allows a net body to deform and thus absorb the force of impact when subjected to the force of impact.

(2) Furthermore, the guard surface in the present invention is the net body.

According to the aforementioned structure, a net body 4 is caused to deform and thus absorb the force of impact when subjected to the force of impact.

(3) Furthermore, the shock-absorbing members in the present invention have granular substances.

According to the aforementioned structure, the granular substances are caused to move when subjected to the force of impact, thereby allowing the shock-absorbing members to deform as a whole and thus absorb the force of impact

(4) Furthermore, at least one substance selected from the group of sand, earth and stone is used to compose the granular substances in the present invention.

According to the aforementioned structure, the granular substances composed of at least one substance selected from the group of sand, earth and stone are caused to move when subjected to the force of impact, thereby allowing the shock-absorbing members to deform as a whole and thus absorb the force of impact. Particularly, since sand, earth and stone which are large in specific gravity are used in the shock-absorbing members, a shock-absorbing effect due to the movement of the shock-absorbing members is improved.

(5) Furthermore, sands are employed as the granular substances in the present invention, the shock-absorbing members are shock-absorbing bags filled with sands, and a plurality of such shock-absorbing bags are arranged on the mountain side of the guard surface.

According to the aforementioned structure, sands inside the bags are caused to move when subjected to the force of impact, thereby allowing the shock-absorbing members as a whole to deform and thus absorb the force of impact. The guard surface is also caused to deform when subjected to a force of impact applied thereto by the shock-absorbing members, and thus absorb the force of impact. In this sense, the force of impact is allowed to be effectively absorbed by the shock-absorbing members and the deformable guard surface.

(6) Furthermore, the shock-absorbing members in the present invention are structural bodies formed by piling up the granular substances on the mountain side of the guard surface.

According to the aforementioned structure, the shock-absorbing structural bodies are caused to deform when subjected to the force of impact, thus allowing the force of impact to be absorbed. The guard surface is also caused to deform when subjected to a force of impact applied thereto by the shock-absorbing structural bodies, and thus absorb the force of impact. In this sense, the force of impact is allowed to be effectively absorbed by the shock-absorbing structural bodies and the deformable guard surface.

(7) Furthermore, stones are employed as the granular substances in the present invention, the shock-absorbing members are gabions formed by loading gabion main bodies with stones, and a plurality of such gabions are arranged on the mountain side of the guard surface.

According to the aforementioned structure, the gabions are caused to deform when subjected to the force of impact, thereby allowing the force of impact to be absorbed. The guard surface is also caused to deform when subjected to a force of impact applied thereto by the gabions, and thus absorb the force of impact. In this sense, the force of impact is allowed to be effectively absorbed by the gabions and the deformable guard surface.

(8) Furthermore, the supporting bodies in the present invention are support posts vertically installed at intervals, and the guard surface is provided between such posts.

According to the aforementioned structure, since the guard surface is provided between the posts, the shock-absorbing effect can be improved.

(9) Furthermore, the guard surface in the present invention comprises a plurality of rope members provided between the posts.

According to the aforementioned structure, the force of impact can be effectively absorbed due to deformation behaviors of the shock-absorbing members and a plurality of the rope members.

(10) Furthermore, the shock-absorbing members in the present invention are disposed on the guard surface.

According to the aforementioned structure, the deformable guard surface is caused to deflect downwardly by a predetermined amount due to weights of the shock-absorbing members in a setting state, thereby reducing a tension force applied to the posts by the guard surface, and thus reducing forces applied to the supporting bodies when subjected to the force of impact.

### Effects of the Invention

According to the aforementioned structure, by combining the deformable guard surface and the shock-absorbing members, a force of impact due to rockfall or the like can be effectively absorbed due to deformation behaviors of the shock-absorbing members and the guard surface, thus providing a guard surface structure excellent in shock-absorbing effect.

### BRIEF DESCRIPTION OF THE DRAWINGS

FIG. 1 is a plan view of a guard body comprising a guard surface structure of a first embodiment of the present invention.

FIG. 2 is a plan view showing a state in which the guard body of the first embodiment of the present invention has been impacted by a falling rock.

FIG. 3 is a front explanatory view of the guard body of the first embodiment of the present invention.

FIG. 4 is a side view of the guard body of the first embodiment of the present invention.

FIG. 5 is a front view of a wire net in the first embodiment of the present invention.

FIG. 6 is an enlarged front view of an essential portion of the wire net of the first embodiment of the present invention.

FIG. 7 is a plan view showing a state in which the wire net is attached to a trestle, in the first embodiment of the present invention.

FIG. 8 is a side view showing the state in which the wire net is attached to the trestle, in the first embodiment of the present invention.

FIG. 9 is a series of graph charts showing relationships between support reactions and time in test examples S, and relationships between weight forces of impact and time in test examples S, in the first embodiment of the present invention.

FIG. 10 is a series of graph charts showing relationships between support reactions and time in comparative examples N, and relationships between weight forces of impact and time in comparative examples N, in the first embodiment of the present invention.

FIG. 11 is a series of graph charts showing relationships between support reactions and time in test examples D, and relationships between weight forces of impact and time in test examples D, in the first embodiment of the present invention.

FIG. 12 is a series of graph charts showing relationships between impulses and time in the test examples S, in the first embodiment of the present invention.

FIG. 13 is a set of graph charts showing relationships between absorbed energies and displacements in the first embodiment of the present invention.

FIG. 14 is a graph chart showing relationships between falling heights and forces of impact in the first embodiment of the present invention.

FIG. 15 is a set of graph charts showing relationships between forces of impact and time in the first embodiment of the present invention, in which FIG. 15A is a graph chart concerning a comparative example N-3, and FIG. 15B is a graph chart concerning a test example S-3.

FIG. 16 is a plan view of a guard body comprising a guard surface structure of a second embodiment of the present invention.

FIG. 17 is a front explanatory view of the guard body of the second embodiment of the present invention.

FIG. 18 is a side view of the guard body of the second embodiment of the present invention.

FIG. 19 is a side view of a guard body comprising a guard surface structure of a third embodiment of the present invention.

FIG. 20 is a plan view of the guard body of the third embodiment of the present invention.

FIG. 21 is a plan view of a guard body comprising a guard surface structure of a fourth embodiment of the present invention.

FIG. 22 is a front explanatory view of the guard body of the fourth embodiment of the present invention.

FIG. 23 is a side view of the guard body of the fourth embodiment of the present invention.

FIG. 24 is a side view of a partial cross section illustrating a construction procedure in the fourth embodiment of the present invention

FIG. 25 is a plan view of a guard body comprising a guard surface structure of a fifth embodiment of the present invention.

FIG. 26 is a plan view of a guard body comprising a guard surface structure of a sixth embodiment of the present invention.

FIG. 27 is a side view of the guard body of the sixth embodiment of the present invention.

FIG. 28 is a cross sectional view of a guard body comprising a guard surface structure of a seventh embodiment of the present invention.

FIG. 29 is a side view of the guard surface structure of the guard body of the seventh embodiment of the present invention.

### BEST MODE FOR CARRYING OUT THE INVENTION

Preferable embodiments of the present invention are described with reference to the accompanying drawings. However, the embodiments described hereunder are not intended to limit the contents of the present invention described in the scope of claims. Further, not all the structures described hereunder are necessarily the essential elements of the present invention. According to each embodiment, a new guard surface structure different from the conventional ones is employed, thereby obtaining a nonconventional guard surface structure described hereunder.

### First Embodiment

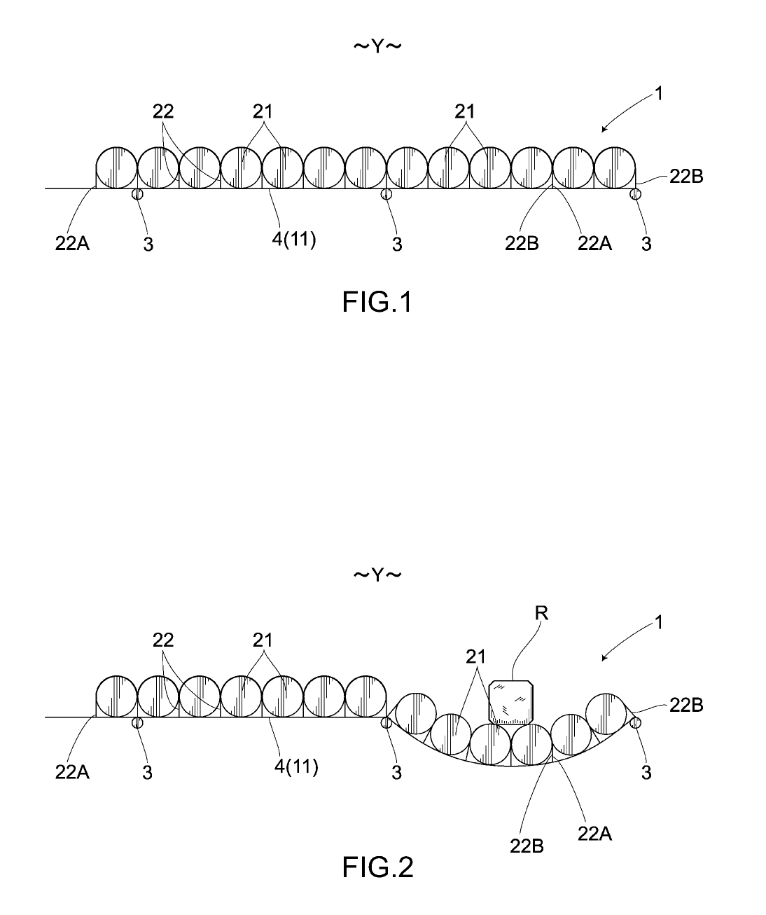

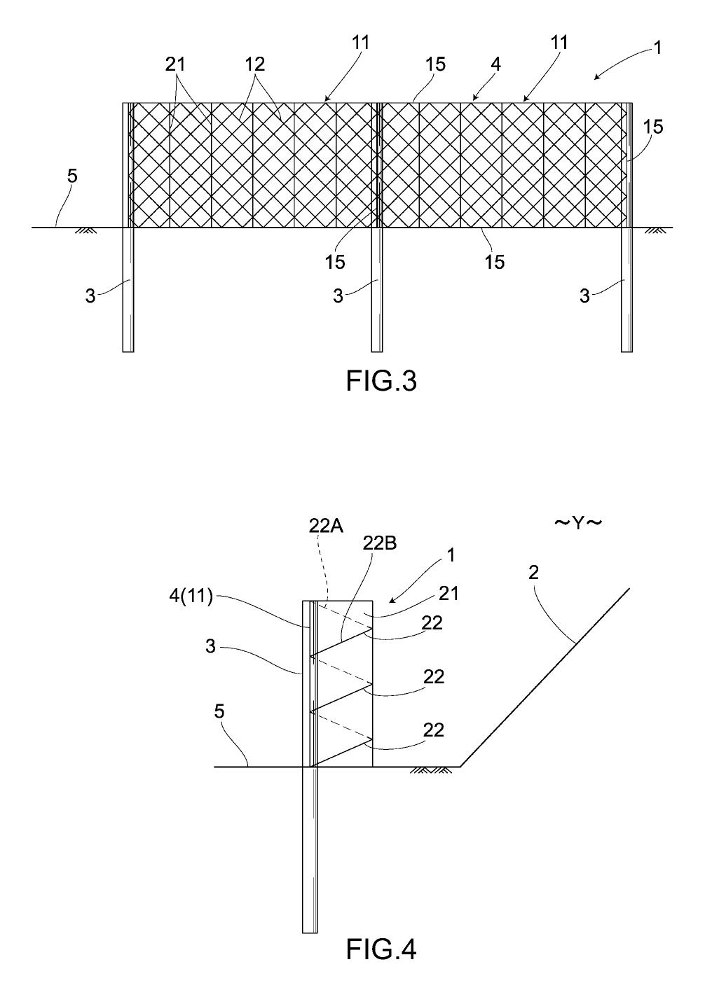

A first embodiment of the present invention is described hereunder with reference to FIG. 1 through FIG. 7. As shown in FIG. 1, a guard fence 1 serving as a guard body for rockfall, avalanche, mudslide or the like comprises a plurality of posts 3, 3 vertically installed at predetermined intervals on an installation location below a slope 2. With regard to such posts 3, 3 aligned in a left-right direction, a flexible net body 4 serving as a guard surface is provided between adjacent posts 3, 3. Here, the installation location is a ground surface 5, and steel pipes having circular cross sections are employed as the posts 3, 3. Further, according to the present embodiment, lower portions of the posts 3, 3 are inserted into the ground surface 5 and fixed therein. Particularly, a drill hole is formed on the ground surface 5 so as to allow the lower portion of the post 3 to be inserted thereinto. The drill hole is then filled up with a filling material, thereby allowing the post 3 to be vertically installed therein. Here, the posts 3 serve as supporting bodies for supporting the net body 4.

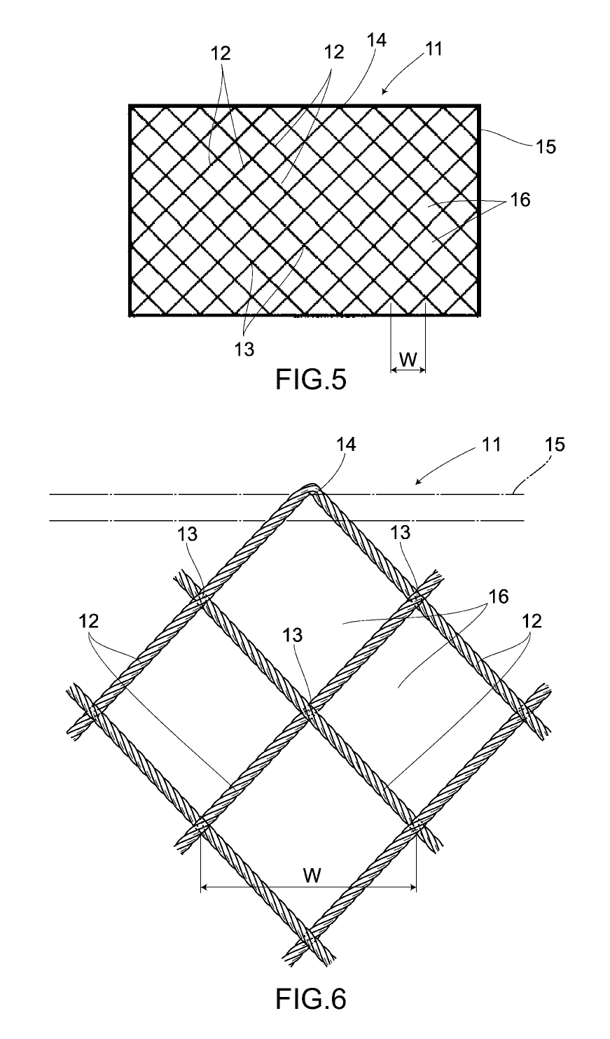

As shown in FIG. 5 and FIG. 6, the net body 4 comprises a wire net 11 in which a plurality of oblique wire members 12, 12 intersect with one another, such oblique wire members 12, 12 being made of twisted steel wires. At a net body intersection portion 13 of the oblique wire members 12, 12, an other oblique wire member 12 is so weaved into one oblique wire member 12 that it is actually inserted through the one oblique wire member 12. With regard to net body intersection portions 13 adjacent to one another in a longitudinal direction of the oblique wire member 12, there are alternately arranged a net body intersection portion 13 in which the other oblique wire member 12 is inserted through the one oblique wire member 12, and a net body intersection portion 13 in which the one oblique wire member 12 is inserted through the other oblique wire member 12. Further, the one oblique wire member 12 of the wire net 11 is so arranged that it obliquely extends from upper left to lower right, while the other oblique wire member 12 is so oppositely arranged that it obliquely extends from upper right to lower left. Such oblique wire members 12, 22 have net body turn-down portions 14 turned down at an angle of substantial 90 degrees on an edge of the net body 4. The oblique wire members 12, 12 are continuous at such net-body turn-down portions 14. Further, an edge rope member 15 is provided on the left, right, top and bottom of a circumference of the wire net 11, such edge rope member 15 being inserted through the net-body turn-down portions 14. Furthermore, each wire net 11 has a width corresponding to the interval between the adjacent posts 3, 3, and there is stretched one wire net 11 between each pair of the adjacent posts 3, 3. Particularly, upper left and right corner portions and lower left and right corner portions of the wire net 11 are fixed to the adjacent posts 3, 3. In this case, two portions of the edge rope member, including an upper and a lower corner portions thereof are fixed to the posts 3, 3. Here, the edge rope member may be fixed to the post 3 through three or more portions thereof on both a left side and a right side, or, adjacent wire nets 11, 11 may also be linked to one another. Further, there can be superimposed on the net body 4 a net body (not shown) such as a wire mesh or the like having a mesh pattern smaller than a mesh pattern 16 of the wire net 11, or the net body 4 may be composed of only the wire net 11.

A shock-absorbing bag 21 serving as a shock-absorbing member is provided on a mountain side Y (slope 2 side) of the net body 4. Particularly, a plurality of the shock-absorbing bags 21 are aligned thereon in a manner such that they substantially cover a whole area of the guard surface 3. The shock absorbing member of the present embodiment contains granular substances such as sands or the like, and is actually a series of the shock-absorbing bags 21 formed by loading cylindrical-shaped bags with the granular substances. The shock-absorbing bag 21 is formed into a substantial cylindrical shape that is vertically long, and is substantially the same height as an upper portion of the post 3. Particularly, a plurality of the shock-absorbing bags 21 are aligned in a left-right direction with no space formed therebetween. Further, the shock-absorbing bag 21 is allowed to stand straight on its own, since an under surface thereof is formed flat. Here, other than sands, there can be employed various granular substances including sands, earths, stones such as fieldstones, crushed stones or the like, wood pieces, wood chips and the like. Also, two of such substances can be mixed with one other and then used as a granular substance. In addition, sands, earths and stones are preferably used as the granular substances, since they have high compressive strengths and are not easily subjected to compression failure. Therefore, at least one substance selected from the group of sand, earth and stone is used as the granular substance.

Further, the shock-absorbing bag 21 is fixed to the net body 4 by means of a fixing rope member 22 serving as a fixation member. Particularly, one end 22A of the fixing rope member 22 is linked to an upper end of the wire net 11 so as to allow the fixing rope member 22 to be obliquely wound around the shock-absorbing bag 21, and an other end 22B of the fixing rope member 22 to then be linked to the wire net 11. Such oblique fixing rope members 22 are provide in the form of multiple rows (three rows in the drawing). Further, with regard to shock-absorbing bags 21 aligned next to the posts 3, either the one end 22A or the other end 22B of the fixing rope member 22 is linked to either an upper end or a lower end of the post 3. Here, the fixing rope member 22 is formed into a substantial “U” shape in a plan view.

And then, once the mountain side of the net body 4 has been subjected to a force of impact due to rock fall or the like, the shock-absorbing bags 21 will deform and absorb the force of impact. Further, at that time, the net body 4 will also undergo deformation due to a force of impact applied thereto by the shock-absorbing bags 21, and thus absorb the force of impact. In this way, the force of impact is allowed to be effectively absorbed by the deformable net body 4 and the shock-absorbing bags 21 filled with sands serving as shock-absorbing materials.

In this case, once a force of impact has been applied by a falling rock R or the like, the net body 4 will undergo deformation and absorb the force of impact. At that time, the force of impact will be absorbed as a plurality of the shock-absorbing bags 21 move along with the net body 4 as shown in FIG. 2. In this sense, the force of impact is expected to be significantly absorbed with the movement of the shock-absorbing bags 21, when using shock-absorbing materials such as sands or the like with large specific gravities instead of shock-absorbing materials with small specific gravities.

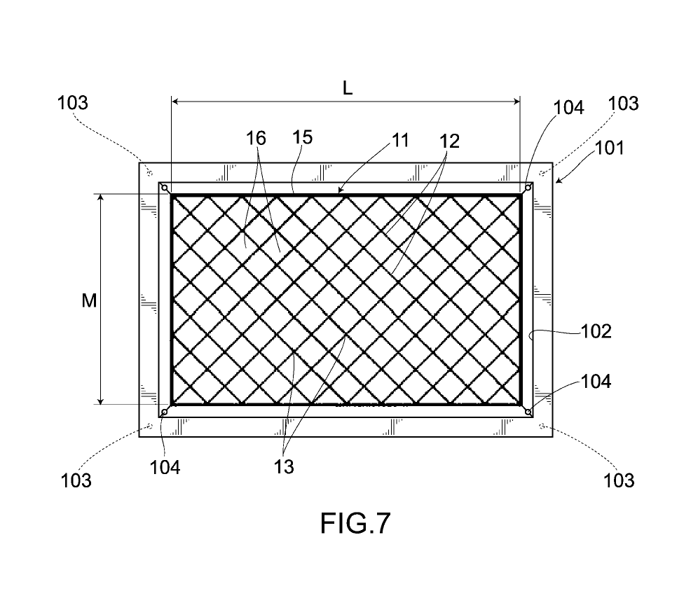

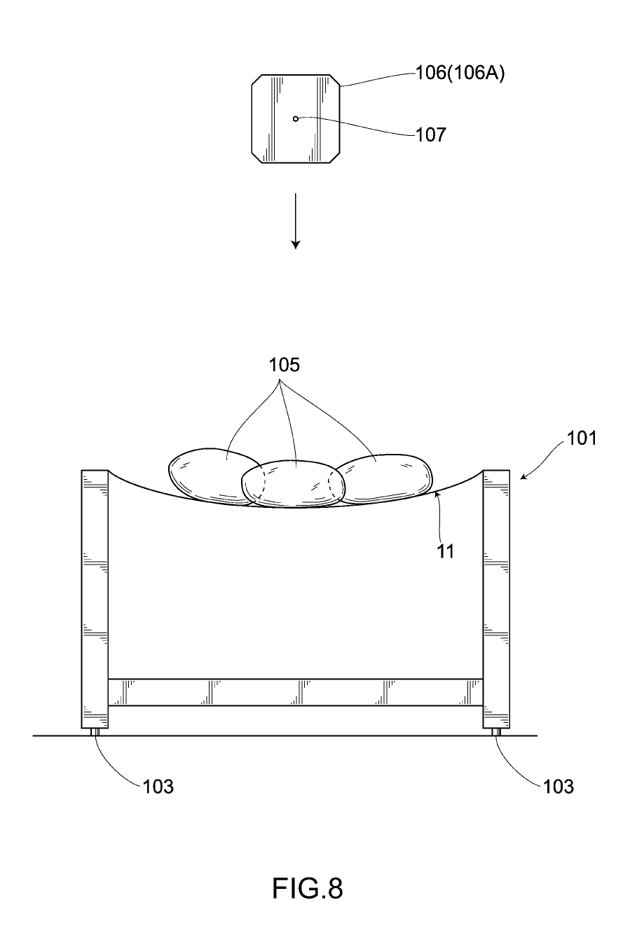

Next, an experimental example using a deformable net body and a shock-absorbing material is described hereunder. As shown in FIG. 7 and FIG. 8, there was formed a trestle 101 made of steel or the like and having a substantially cuboid shape. The wire net 11 was stretched across an upper surface opening 102 of the trestle 101. As shown in a plan view of FIG. 7, a length L of the wire net 11 was 3 m, and a width thereof was 5 m. A diameter of the aforementioned edge rope member 15 was 30 mm, and a tension strength thereof was 1470 N/mm². A diameter of the oblique wire member 12 was 12 mm, and a tension strength thereof was 1470 N/mm². A distance W between the adjacent intersection portions of the oblique wire members 11, 11 was 500 mm. Further, there was superimposed on the wire net 11 a wire mesh (not shown) having a wire diameter of 2.7 mm and mesh patterns as large as 80 mm×100 mm.

A load sensor 103 (500 kN) for support reaction measurement was disposed on a lower portion of the trestle 101, for measuring a reaction applied to the trestle 101. Specifically, the load sensor 103 was provided on a lower portion of each one of four leg portions 101A of the trestle 101. Further, four corner portions of the wire net 11 were linked to the trestle 101, and a load sensor 104 (500 kN) was disposed on each portion at which a corner portion of the wire net 11 was linked to the trestle 101. Furthermore, shock-absorbing bags 105 filled with sands serving as shock-absorbing materials were placed on the wire net 11. Here, the shock-absorbing bag 105 was formed by loading a sandbag with sands of 15 kN. Particularly, six shock-absorbing bags 105 were placed on the wire net 11. The wire net 11 was, therefore, deflected due to weights of the shock-absorbing bags 105.

In test examples S-1 through S-10 of the present invention, and comparative examples N-1 through N-4 other than the present invention, there was used a weight 106 of 10 kN formed by filling a steel shell with mortar. Further, a height H from the wire net 11 was set to 3-10 m, and the weight 106 was allowed to free-fall from each height. In test examples D-1 through D-10 of the present invention, there was used a weight 106A formed by filling a large sandbag with sands of 10 kN. Further, a height H from the wire net 11 was set to 3-10 m, and the weight 106A was allowed to free-fall from each height. Here, a triaxial accelerometer 107 (100 G) was disposed in the center of the weight 106.

The weight 106 was assumed to be a falling rock, while the weight 106A was assumed to be soft earth and sand or the like.

Next, in the comparative examples N-1 through N-4, no shock-absorbing bag 105 was placed on the wire net 11. The following table 1 shows heights H in the test examples S-1 through S-10, comparative examples N-1 through N-4 and test examples D-1 through D-10.

TABLE 1

| | | Weight of | | |
|---|---|---|---|---|
| | Falling | shock-absorbing | Type of | Weight of |
| Example | height | sand | weight | weight |
| S-3 | 3.0 m | 90 kN | Concrete | 10 kN |
| S-4 | 4.0 m | 90 kN | Concrete | 10 kN |
| S-5 | 5.0 m | 90 kN | Concrete | 10 kN |
| S-6 | 6.0 m | 90 kN | Concrete | 10 kN |
| S-8 | 8.0 m | 90 kN | Concrete | 10 kN |
| S-10 | 10.0 m | 90 kN | Concrete | 10 kN |
| N-1 | 1.0 m | — | Concrete | 10 kN |
| N-2 | 2.0 m | — | Concrete | 10 kN |
| N-3 | 3.0 m | — | Concrete | 10 kN |
| N-4 | 4.0 m | — | Concrete | 10 kN |
| D-5 | 5.0 m | 90 kN | Sand | 10 kN |
| D-6 | 6.0 m | 90 kN | Sand | 10 kN |
| D-8 | 8.0 m | 90 kN | Sand | 10 kN |
| D-10 | 10.0 m | 90 kN | Sand | 10 kN |

Here, with regard to the types of the weighs in table 1, “concrete” refers to the weight 106 formed by loading the steel shell with mortar, while “sand” refers to the weight 106A formed by loading the large sandbag with sand.

Next, a support reaction applied to the trestle 101 when the weight was dropped was measured by the load sensor 103, and a tension force applied to the wire net 11 when the weight was dropped was measured by the load sensor 104. Further, an acceleration of the weight falling was measured by the acceleration sensor 107. With regard to each one of the measurements, data sampling was carried out at a rate of 5 kHz. Further, a high-speed video camera was used to confirm deformation behaviors, and carry out photographing at a speed of 1000 frames per second. Here, in test examples D-5 through D-10, since the sandbag weight 106A was used, acceleration was not measured.

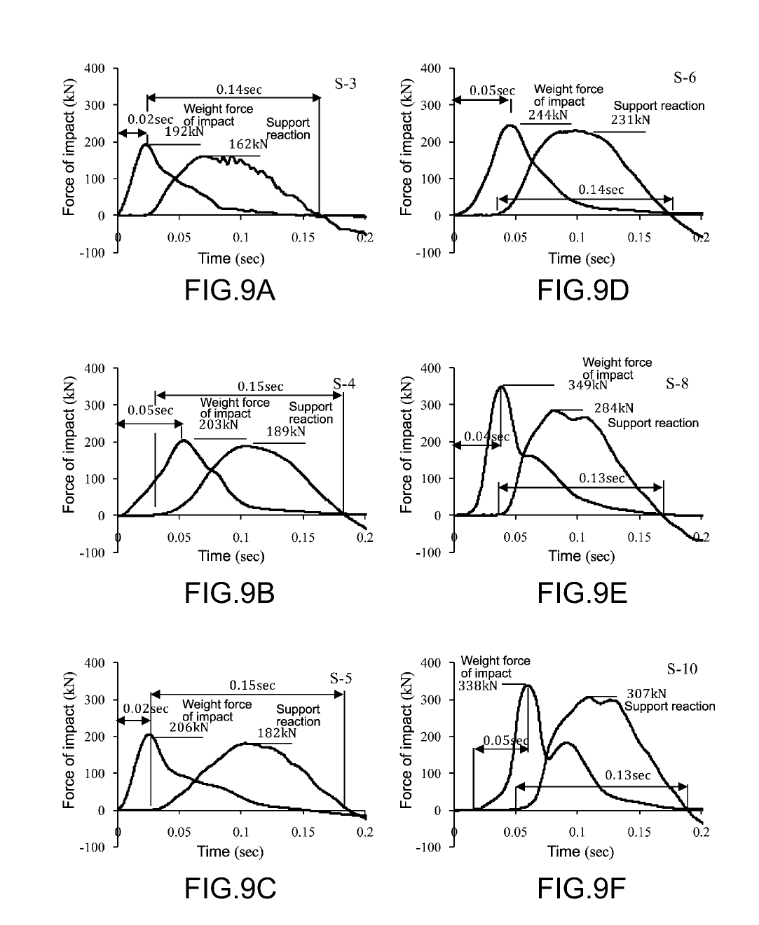

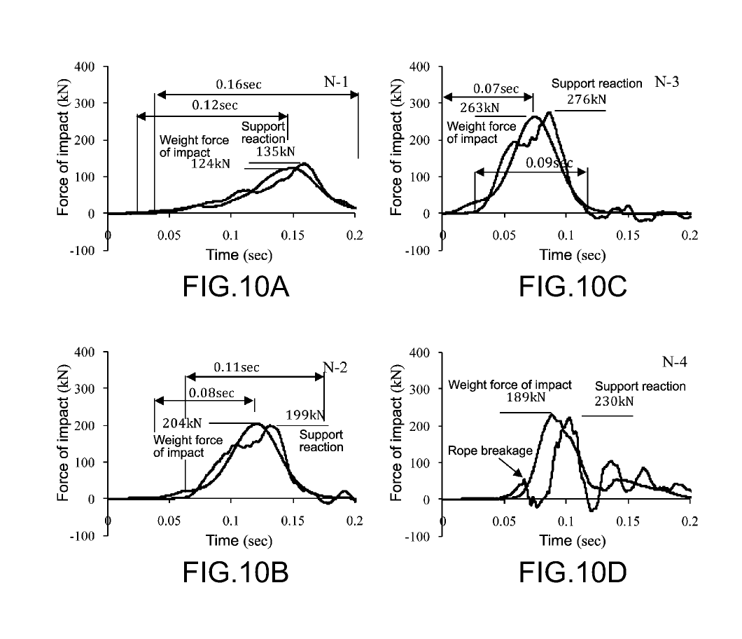

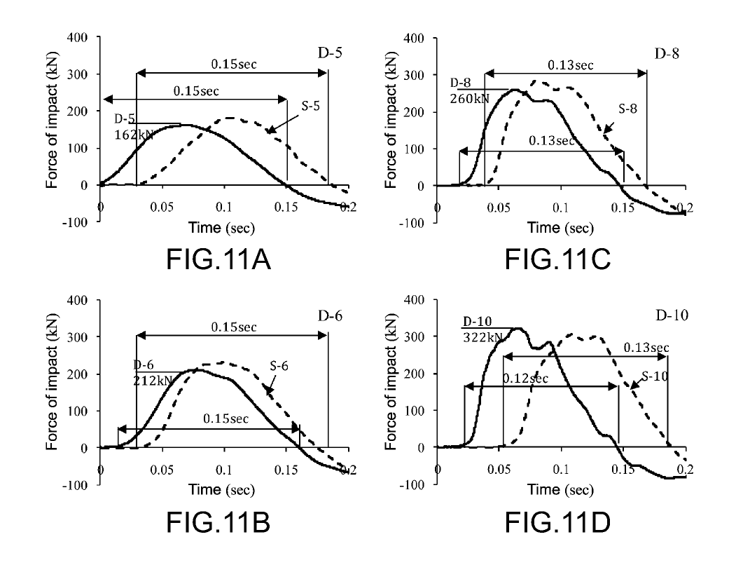

Changes in a weight force of impact and the support reaction with time are shown in FIG. 9A through FIG. 9F, FIG. 10A through FIG. 10D and FIG. 11A through FIG. 11D, in which the vertical axis represents the weight force of impact and the support reaction measured by the load sensor 103 of the trestle 101, while the horizontal axis represents time. The weight force of impact was calculated by multiplying the acceleration of the weight by the weight thereof. Here, only the support reaction is shown in FIG. 11A through FIG. 11D.

As shown in FIG. 9A through FIG. 9F and in the test examples S-1 through S-10, the time required for the weight force of impact to reach a maximum value from a rise of load was 0.02-0.05 seconds, and a duration thereof was 0.15-0.18 seconds. The support reaction was first observed around the time when the weight force of impact had reached the maximum value, and a duration thereof was 0.13-0.15 seconds. Further a maximum value of the support reaction was observed to be slightly smaller than that of the weight force of impact.

As shown in FIG. 10A through FIG. 10D and in the comparative examples N-1 through N-4, it took the weight force of impact longer to reach a maximum value from the rise of load as compared to the test examples S, in particular, about 0.07-0.12 seconds. The maximum value of the weight force of impact was 135 kN-276 kN, which was larger than that of the test examples S. When a falling height was 3 m, a maximum weight force of impact in the comparative example N-3 was 263 kN which was 1.37 times larger than a maximum weight force of impact of 192 kN in the test example S-3. Here, the weight force of impact in the comparative example N-4 was observed to be smaller than that of the comparative example N-3. The reason for that was because an energy was absorbed due to breakage of the wire net 11. The duration of the support reaction was 0.08-0.16 seconds, and the higher the falling height was, the shorter the duration of the support reaction became.

In the test examples D-5 through D-10, the weight force of impact was not measured, since the sandbag weight 106A was dropped. In FIG. 11A through FIG. 11D, wave shapes of the test examples S-5 through S-10 are also shown therein as broken lines in order to help compare the differences between the kinds of the weights.

When comparing the support reactions in the test examples D-5 through D-10 to those in the test examples S-5 through S-10, it was observed that the maximum values and durations thereof were substantially the same, and that wave shapes thereof resembled one another. Here, a time lag in a rise of the support reaction was not due to the timing of rise of an impact, but due to a time lag in starting of the measurement. In this sense, it was found that there was no difference between the hard weight 106 and the sandbag weight 106A in terms of superiority in response of the support reaction with respect to a soft supporting surface formed by placing the shock-absorbing bags 21 (i.e., large sandbags) on the wire net 11

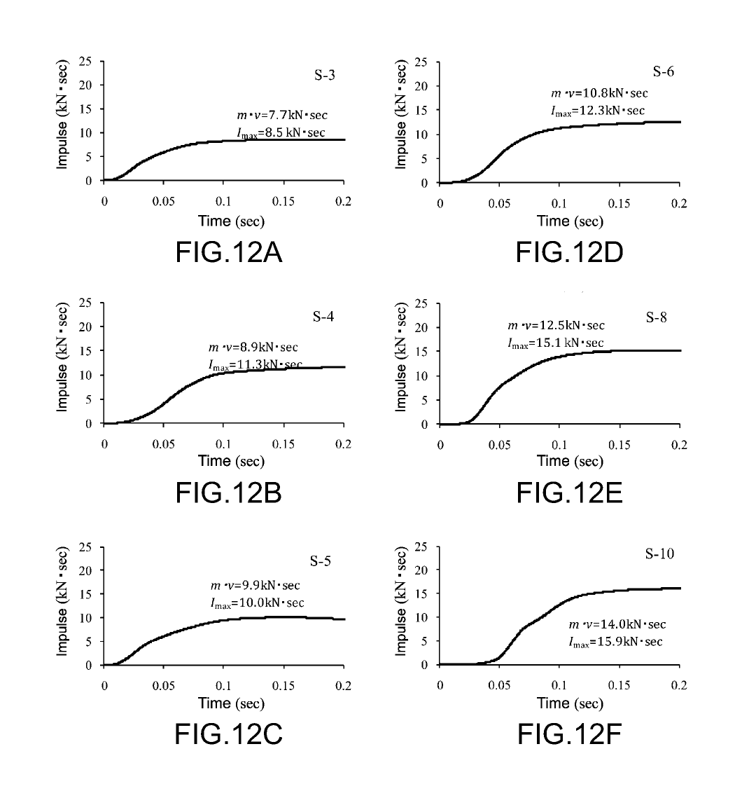

FIG. 12A through FIG. 12F show changes in impulse with time in the test examples S-5 through S-10. Impulse was calculated by integrating the weight force of impact with time.

The impulses in the test examples S-5 through S-10 were 10%-20% larger than initial momentums m·v of the weight at the time of impact. With regard to an impact on sands put on a rigid structure such as a rock shed or the like, the weight will intrude into the shock-absorbing sands and there will be substantially no rebound, thus causing the impulse and the initial momentum to be equivalent to one another. However, in the present experiment, the wire net 11 did not reach its limitation, thereby allowing the weight to rebound due to a relatively slow elastic behavior of the wire net 11, and thus resulting in large values of the impulses.

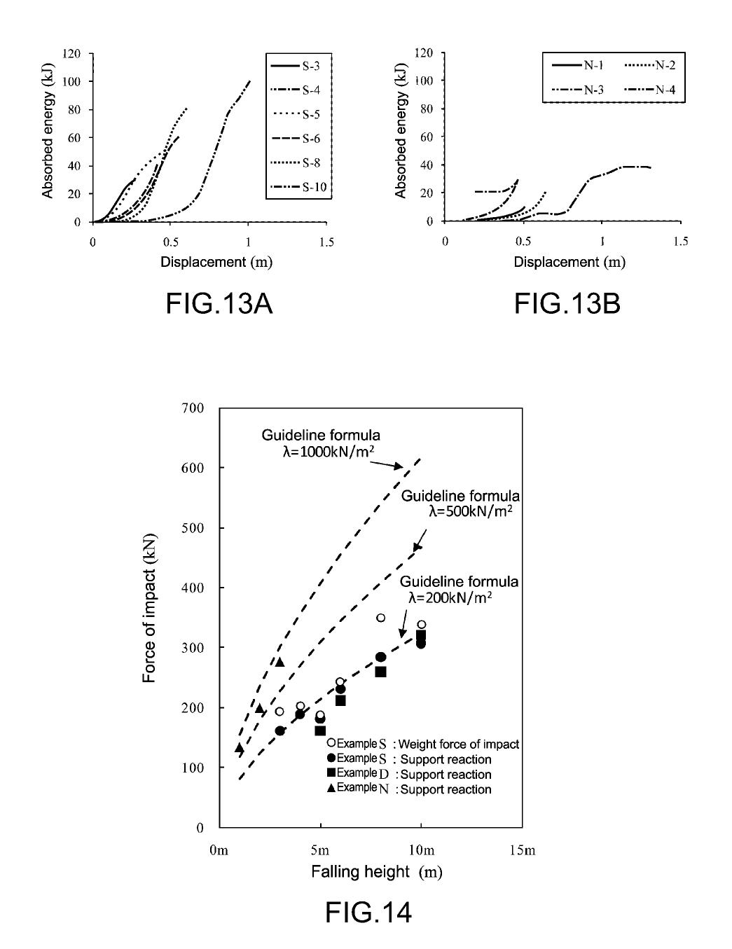

FIG. 13A and FIG. 13B show how an absorbed energy and a displacement are interrelated with one another. Here, the displacement was calculated by integrating the acceleration with time twice, and the absorbed energy was calculated by integrating the load with the displacement. The absorbed energy was represented by an area surrounded by the load and the displacement. In the test examples S-5 through S-10, it was observed that a slope representing the correlation between the displacement and a displacement energy became slightly steeper as the falling height got higher. It was assumed that the reason for that was because the sands had been caused to pack, since the weight was dropped in a style of gradual loading. However, it was observed that the absorbed energy was substantially proportionate to the displacement when the displacement energy was maximum.

In the comparative examples N-1 through N-4, changes in a slope of the absorbed energy due to the falling height were not observed. In the comparative example N-4, there was observed a relatively complex correlation in which the displacement kept increasing with the energy remaining constant before reaching approximately 0.75 m, and the energy largely increased again thereafter. This was due to the breakage of the wire net 11.

With regard to the deformation of the wire net 11 and in the test examples S in which large sandbag-type shock-absorbing bags 21 were placed on the wire net 11, the weight 106 intruded into the shock-absorbing bags 21 by approximately 1 m in the test example S-10 in which the weight 106 was dropped at a height of 10 m. However, the wire net 11 as a whole underwent deformation of up to approximately 93 mm. On the other hand, in a case in which the shock-absorbing bags 21 were not placed, the wire net 11 broke when the falling height was 4 mm, thus indicating that the shock-absorbing bags 21 were capable of preventing localized damages inflicted on the wire net 11.

In this sense, it was confirmed that the localized damages inflicted on the wire net 11 and the deformation amount thereof could be reduced by placing the shock-absorbing bags 21 on the wire net 11, which is suitable for use in a protecting work with small deformation amount.

TABLE 2

| | Weight force | Support | Response |
|---|---|---|---|
| | of impact | reaction | ratio |
| Example | P(kN) | R(kN) | R/P |
| S-3 | 193 | 161 | 0.84 |
| S-4 | 203 | 189 | 0.93 |
| S-5 | 189 | 181 | 0.96 |
| S-6 | 244 | 231 | 0.95 |
| S-8 | 349 | 284 | 0.81 |
| S-10 | 338 | 307 | 0.91 |
| N-1 | 123 | 135 | 1.09 |
| N-2 | 204 | 199 | 0.98 |
| N-3 | 263 | 276 | 1.05 |

Table 2 shows maximum values of the weight force of impact and the support reactions, in the test examples S and the comparative examples N. A response ratio in the table was a ratio obtained by dividing the weight force of impact which is an input load by the support reaction which is a transmission load.

In the test examples S in which the shock-absorbing bags 21 were placed on the wire net 11, the value of the support reaction was 0.84-0.96 of the weight force of impact. And, in the comparative examples N in which the weight was dropped directly on the wire net 11, the value of the support reaction was 0.98-1.09 of the weight force of impact.

When comparing the comparative example N-3 and the test example S-3 that are equivalent to each other in terms of a collision speed, namely, impact energy of the weight, the maximum weight force of impact in the test example S-3 was about 70% of that in the comparative example N-3 in which the weight was dropped directly on the wire net 11. Further, the maximum value of the support reaction in the test example S-3 was about 60% of that in the comparative example N-3 in which the weight was dropped directly on the wire net 11 This was because the force of impact was reduced due to a shock-absorbing effect of the sands.

FIG. 14 shows a correlation between the falling height and the force of impact. Guideline formulas in FIG. 14 were obtained using a force of impact formula found in a guideline for rockfall countermeasure (published by: Japan Road Association 2000).

The following formula (1) is a rockfall countermeasure guideline formula.

P=2.108·(m·g)^{2/3}·H^{2/3}·H^{3/5}·λ^{2/5} (1)

Here, “m” represents the mass of a falling rock (t), “g” represents an acceleration of gravity of 9.806 m/sec², “H” represents the falling height (m), and “λ” represents a Lame's constant (kN/m²).

In the present experiment, the support reactions in the comparative examples N were found to be substantially identical to forces of impact calculated using a Lame's constant of λ=1000 kN/m². And, in the test examples S and the test examples D, although the values of the weight forces of impact in the test examples S were slightly large, the support reactions were found to be substantially identical to forces of impact calculated using a Lame's constant of λ=200 kN/m².

In this sense, it was found that when falling rocks or earth and sand had impacted a flexible surface formed by placing large sandbag-type shock absorbing bags 11 on the wire net 11, a force of impact thus generated was significantly small as compared to a maximum force of impact inflicted on a sand cushion (λ=1000 kN/m²) generally used in the rock shed.

In this way, it was assumed that the Lame's constant of λ=200 kN/m² could be used for designing posts and joists supporting the wire net 11 while considering the impact inflicted on the present structure due to rockfall or the like as a static load.

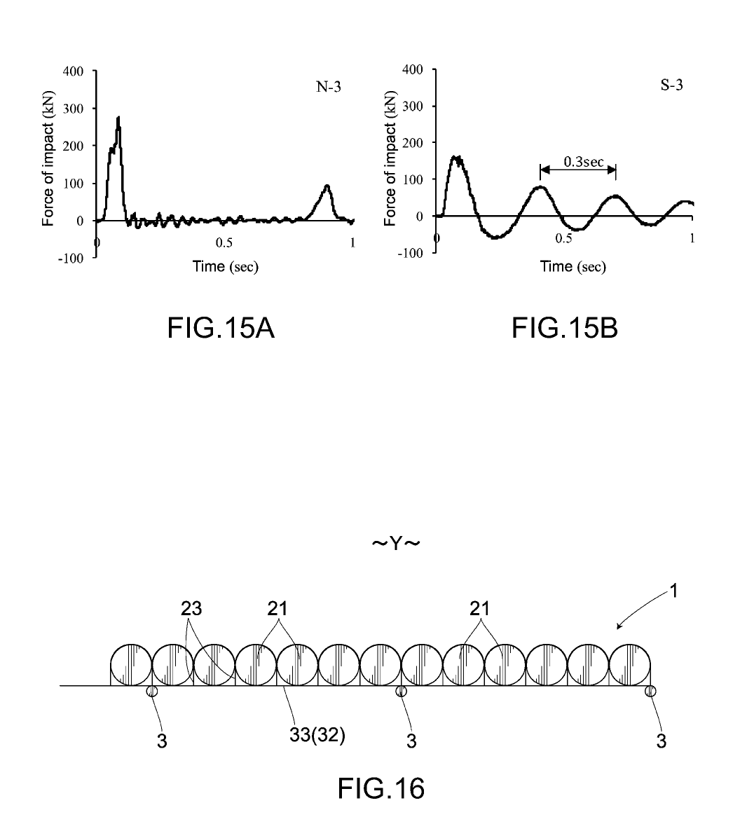

FIG. 15 shows characteristic cycles of response wave shapes of the support reactions in the comparative example N-3 and the test example S-3. In the comparative example N-3, oscillation with a short cycle was observed after the impact due to the weight. It was assumed that this was a vibration of the trestle 101. In the test example S-3, oscillation with a cycle of 0.3 seconds was observed after the impact, such cycle of 0.3 seconds being significantly longer than the characteristic cycle of the comparative example N-3.

A characteristic cycle of one mass point system is defined by the following formula (2).

T=2·π·√(M/k) (2)

Here, “T” represents characteristic cycle (sec), “M” represents mass (t) and “k” represents a spring constant (kN/m). An appropriate value is set for M when considering the response of a structure body, and M is called an effective mass.

It was assumed that the present study could also be expressed using a model of a one mass point system model, and estimation of the maximum force of impact was made using the displacements obtained in the experiment.

Since the characteristic cycle was expressed in the formula (2), the spring constant was obtained using a formula (3). Here, the effective mass only includes the mass of the sandbags placed on the wire net, since the mass of the wire net 11 was significantly small as compared to that of the shock-absorbing bags 21 and was thus ignored.

k=M/T²·(2·π)²=9/0.3²·(2·π)²=3943 kN/m (3)

Here, “T” represents the characteristic cycle of 0.3 (sec), “k” represents a spring constant of the wire net (kN/m) and “M” represents an effective mass of 9.0 (t).

TABLE 3

| | | Calculated | Support | |
|---|---|---|---|---|
| | Displacement | value | reaction | |
| Example | δ(mm) | P(kN) | R(kN) | R/P |
| S-3 | 48 | 189 | 161 | 0.853 |
| S-4 | 50 | 197 | 189 | 0.957 |
| S-5 | 71 | 280 | 181 | 0.648 |
| S-6 | 70 | 276 | 231 | 0.836 |
| S-8 | 83 | 327 | 284 | 0.868 |
| S-10 | 93 | 367 | 307 | 0.838 |

Table 3 shows a calculated value obtained by multiplying a maximum displacement calculated based on images of the high-speed video camera by the spring constant, and the support reactions obtained in the experiment. The calculated values were found to be substantially identical to the experimental values, except for the test example S-5 in which the weight tipped at the time of impact.

The following points were confirmed through the aforementioned experiment.

(1) With regard to the flexible supporting surface formed by placing the large sandbag-type shock-absorbing bags 21 on the wire net 11, it was found that there was no difference between the weight 106 and the sandbag weight 106A in terms of superiority in the response of the support reaction, and that both rockfall and mudslide could be effectively dealt with accordingly.

(2) The weight force of impact inflicted on the wire net 11 alone used in the present experiment was comparable with a value calculated using the rockfall countermeasure guideline formula when λ=1000 kN/m².

(3) When sandbags were placed on the flexible wire net 11, it was found that the weight force of impact was equivalent to a value calculated using the rockfall countermeasure guideline formula when λ=200 kN/m².

(4) Experimental values of the support reactions were substantially identical to loads calculated based on a correlation between the displacement of the wire net and the spring constant obtained based on the characteristic cycle of the one mass point system model.

The guard surface structure of the present embodiment comprises the net body 4 serving as a guard surface supported by the supporting bodies. The net body 4 is deformable, and the shock-absorbing bags 21 serving as shock-absorbing members are disposed on the mountain side of the net body 4. Therefore, once a force of impact has been applied by the falling rock R or the like, both the deformable net body 4 and the shock-absorbing bag 21 will undergo deformation so as to effectively absorb the force of impact. In this case, the net body 4 is caused to deform after the force of impact has been first applied to the shock-absorbing bags 21, thus allowing the guard surface to deform less. Further, the net body 4 is also allowed to deform less, since the net body 4 is caused to deform after the force of impact has been first applied to the shock-absorbing bags 21.

In the present embodiment, the guard surface is the net body. In this sense, once a force of impact has been applied, the net body 4 will be caused to deform so as to absorb the force of impact.

Further, according to the present embodiment, the shock-absorbing member contains sand serving as a granular substance. In this sense, once a force of impact has been applied, a plurality of sand grains will move so as to cause the shock-absorbing bag 21 to deform as a whole, thereby allowing the force of impact to be absorbed.

Furthermore, according to the present embodiment, at least one substance selected from the group of sand, earth and stone is used as the granular substance. In this sense, once a force of impact has been applied, the granular substance consisting of at least one substance selected from the group of sand, earth and stone will move so as to cause the shock-absorbing bag 21 serving as a shock-absorbing member to deform as a whole, thus allowing the force of impact to be absorbed. Particularly, since substances with large specific gravities such as sand, earth and stone are used to form the shock-absorbing bag 21, a shock-absorbing effect due to the movement of the shock-absorbing bag 21 can be improved.

Furthermore, according to the present embodiment, the granular substance used is sand, the shock-absorbing member is actually the shock-absorbing bag 21 formed by loading a bag with sand, and a plurality of such shock-absorbing bags 21 are aligned on the mountain side of the net body 4 serving as a guard surface. In this sense, once a force of impact has been applied, the sands inside the bag will move so as to cause the shock-absorbing bag 21 to deform, thereby allowing the force of impact to be absorbed. Also, at that time, the net body 4 will undergo deformation due to the force of impact applied thereto by the shock-absorbing bags 21, thus allowing the force of impact to be absorbed. In this way, the force of impact is allowed to be effectively absorbed by the shock-absorbing bags 21 and the deformable net body 4.

Furthermore, according to the present embodiment, the supporting body is actually a series of the posts 3 vertically installed at intervals, and the net body 4 serving as a guard surface is provided between such posts 3. Therefore, a shock-absorbing capability of the guard fence 1 is improved.

Furthermore, as an effect of the present embodiment, since a fixing rope member 22 serving as a fixation member is used to fix the shock-absorbing bags 21 to the wire net 11 of the net body 4, the shock-absorbing bags 21 can be prevented from moving around. In addition, since the shock-absorbing bags 21 are aligned with no space therebetween, a reliable shock-absorbing effect can be achieved.

### Second Embodiment

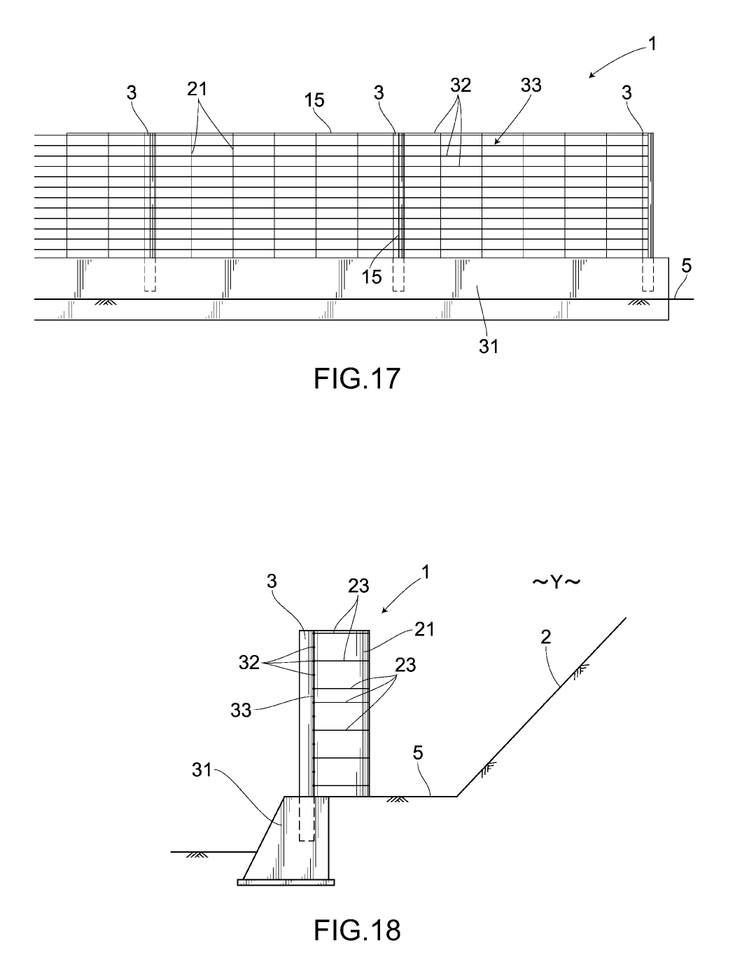

FIG. 16 through FIG. 18 show a second embodiment of the present invention. Same reference numbers are used to describe the same parts as those in the first embodiment, thereby omitting the detailed descriptions of such parts when describing the second embodiment. According to this embodiment, a concrete base 31 is provided on a ground surface 5 below a slope 2 and serving as an installation location. The aforementioned posts 3, 3 . . . are vertically installed in the concrete base 31. And, instead of the net body 4, transverse rope members 32, 32 are provided between the posts 3, 3 . . . in the form of multiple rows, thus forming a guard surface 33. Further, there can be superimposed on such transverse rope members 32, 32 . . . a net body (not shown) such as a wire mesh or the like having a mesh pattern smaller than a vertical space between the transverse rope members 32, 32.

Shock-absorbing members are provided on a mountain side Y (slope 2 side) of the guard surface 33. The shock-absorbing members according to this embodiment are the aforementioned shock-absorbing bags 21. The shock-absorbing bags 21 are aligned on the mountain side of the guard surface 33 in the same way as the first embodiment.

Further, the shock-absorbing bags 21 are fixed to the transverse rope members 32, 32 . . . by means of a fixing rope member 23 serving as a fixation member and provided in the form of multiple rows in a longitudinal direction. Specifically, the fixing rope member 23 is so wound around the shock-absorbing bag 21 that the fixing rope member 23 is actually bended into a substantial “U” shape therearound. Such fixing rope member 23 is provided in the form of multiple rows, and two ends thereof are linked and fixed to the transverse rope member 32. Further, with regard to the shock-absorbing bags 21 disposed next to the posts 3, one end of the fixing rope member 23 is linked to the post 3. Furthermore, while the fixing rope member 23 is annularly wound around the shock-absorbing bag 21, the fixing rope member 23 can also be inserted into the mesh patterns formed by the oblique wire members 12, 12 and linked thereto. Here, according to this embodiment, the two ends of the fixing rope member 23 are substantially positioned at the same height.

Next, once the mountain side of the guard surface 33 has been subjected to a force of impact due to the falling rock R or the like, the shock-absorbing bags 21 will deform and absorb the force of impact. Further, at that time, the guard surface 33 will also undergo deformation due to a force of impact applied thereto by the shock-absorbing bags 21, and thus absorb the force of impact. In this way, the force of impact is allowed to be effectively absorbed by the deformable guard surface 33 and the shock-absorbing bags 21 loaded with sand serving as a shock-absorbing material.

A guard surface structure of this embodiment comprises the guard surface 33 supported by the posts 3 serving as supporting bodies. Such guard surface 33 is deformable, and the guard surface 22 is provided with the shock-absorbing bags 21 serving as shock-absorbing members. Further, the supporting bodies are the posts 3 vertically installed at intervals, and the guard surface 33 is provided between such posts 3, 3 . . . . In this sense, same functions and effects as those of the first embodiment can be achieved with this embodiment.

Further, as an effect of this embodiment, the fixing rope member 23 is provided in the form of multiple rows, thereby allowing the shock-absorbing bags 21 to be stably fixed to the guard surface 33.

### Third Embodiment

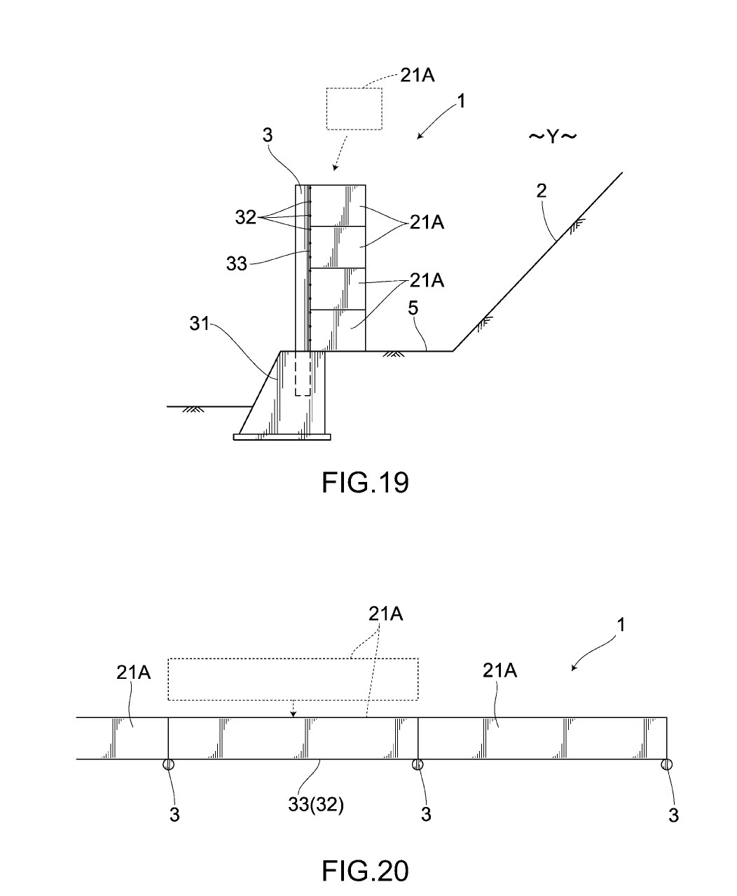

FIG. 19 and FIG. 20 shows a third embodiment of the present invention. Same reference numbers are used to describe the same parts as those in the aforementioned embodiments, thereby omitting the detailed descriptions of such parts when describing the third embodiment. A shock-absorbing bag 21A of this embodiment is horizontally long, and has a substantially rectangular vertical cross sectional shape. According to this embodiment, such vertical cross sectional shape is a substantial square, and the shock-absorbing bag 21A has a length corresponding to an interval between the posts 3, 3.

Further, a plurality of the shock-absorbing bags 21A are stacked up substantially to the height of the guard surface 33. An upper and a lower shock-absorbing bags 21A, 21A are coupled to each other, and each shock-absorbing bag 21A is fixed to the net body 4 by means of a fixation member. Further, shock-absorbing bags 21A, 21A aligned next to each other in a left-right direction of the guard fence 1 are also fixed to one another in front of the posts 3.

Next, once the mountain side of the guard surface 33 has been subjected to a force of impact due to the falling rock R or the like, the shock-absorbing bags 21A will deform and absorb the force of impact. Further, at that time, the guard surface 33 will also undergo deformation due to a force of impact applied to the net body 4 by the shock-absorbing bags 21A, and thus absorb the force of impact. In this way, the force of impact is allowed to be effectively absorbed by the deformable guard surface 33 and the shock-absorbing bags 21 loaded with sand serving as a shock-absorbing material.

In this case, once a force of impact has been applied, the guard surface 33 will undergo deformation and absorb the force of impact. At that time, the force of impact will also be absorbed as a plurality of the shock-absorbing bags 21A move along with the net body 4. In this sense, the force of impact is expected to be more effectively absorbed with the movement of the shock-absorbing bags 21A, when using sand or the like with a large specific gravity instead of a shock-absorbing material with a small specific gravity.

A guard surface structure of this embodiment comprises the guard surface 33 supported by the posts 3 serving as supporting bodies. Such guard surface 33 is deformable, and the guard surface 22 is provided with the shock-absorbing bags 21 serving as shock-absorbing members. Further, the supporting bodies are the posts 3 vertically installed at intervals, and the guard surface 33 is provided between such posts 3, 3 . . . . In this sense, same functions and effects as those of the first embodiment can be achieved with this embodiment.

### Fourth Embodiment

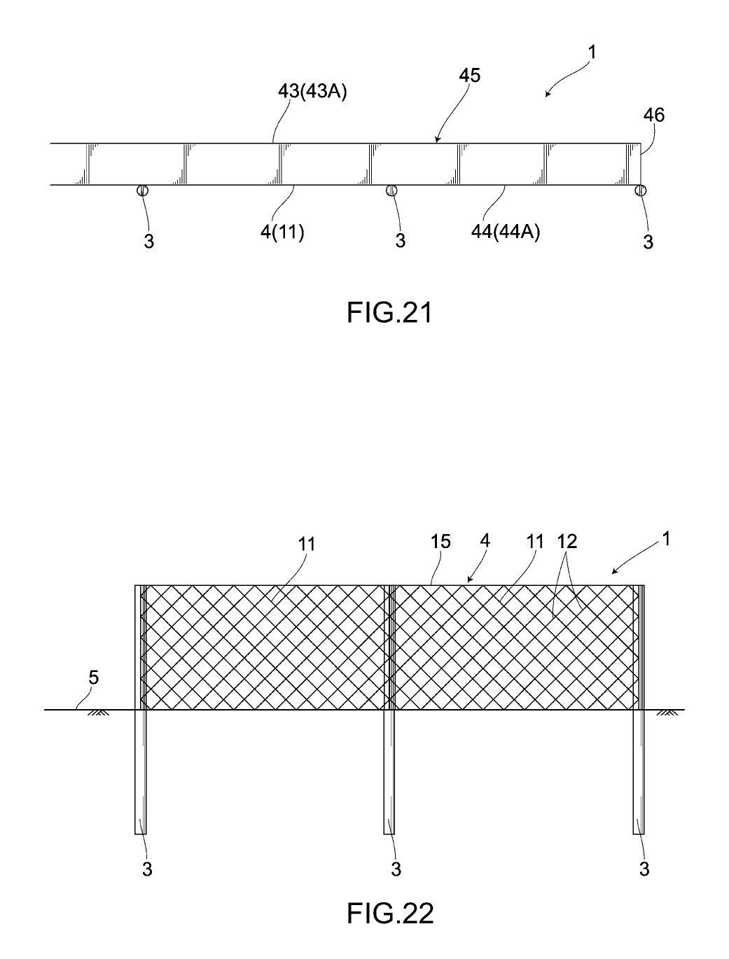

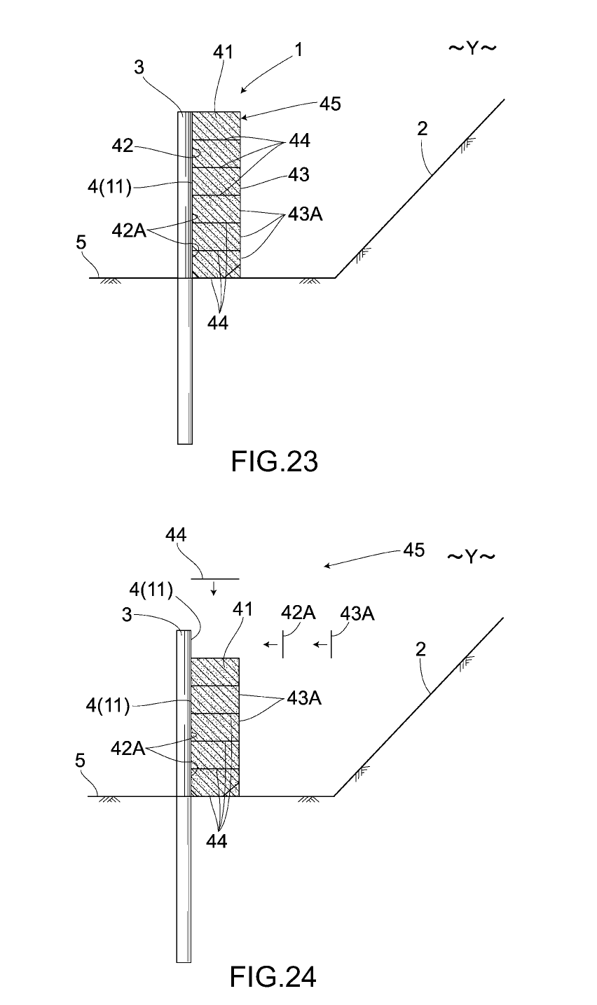

FIG. 21 through FIG. 24 show a fourth embodiment of the present invention. Same reference numbers are used to describe the same parts as those in the aforementioned embodiments, thereby omitting the detailed descriptions of such parts when describing the fourth embodiment. Structures of posts 3 and a net body 4 in this embodiment are as same as those in the first embodiment.

The shock-absorbing member in this embodiment is a shock-absorbing embankment 45 serving as a shock-absorbing structural body and formed by piling up at least one granular substance 41 selected from the group of sand, earth and stone. Such shock-absorbing embankment 45 comprises a rear wall member 42 provided along a mountain side Y of the net body 4 and a front wall member 43 provided apart from the rear wall member 42. And, a filling space between the front wall member 43 and the rear wall member 42 is filled with the granular substance 41. Further, the rear wall member 42 and the front wall member 43 are respectively composed of a plurality of division surface members 42A, 43A arranged in a longitudinal direction. In this sense, the rear wall member 42 and the front wall member 43 are formed by stacking up the division surface member 42A and the division surface member 43A, respectively, in the longitudinal direction. Here, the division surface members 42A, 43A are also arranged in the left-right direction, and are formed into lengths corresponding to, for example, intervals between the posts 3, 3. Further, a sheet-shaped reinforcement member 44 such as a geotextile or the like is disposed at a section in the aforementioned filling space, on which the division surface members 42A, 43A are stacked, thus reinforcing the earth 41 filling the space. Here, a rear portion of the sheet-shaped reinforcement member 44 is linked and fixed to the rear wall member 42 and the wire net 11, while a front portion thereof is linked and fixed to the front wall member 43.

Concrete panels, iron panels, expanded metals, wire nets or the like can be employed as the rear and front wall members 42, 43. If using an expanded metal or a wire net, an absorption prevention material such as a vegetation sheet or the like may be superimposed thereon.

A first row of the division surface members 42A, 43A is disposed, followed by filling a space therebetween with sand, such sand being caused to pack therein. The sheet-shaped reinforcement member 44 is then placed on a layer of the sand thus packed, followed by stacking another row of the division surface members 42A, 43A on such first row constructed. The granular substance 41 is then used to fill the space between those division surface members 42A, 43A and caused to pack therein. The sheet-shaped reinforcement member 44 is then placed on a layer of the granular substance 41 thus packed. Those procedures are actually repeated until heights of the posts 3 have been reached, thus constructing the shock-absorbing embankment 45 serving as a structural body. In addition, a side surface member 46 is provided on end portions of the shock-absorbing embankment 45 in the left-right direction.

Next, once the mountain side Y of the net body 4 has been subjected to a force of impact due to the falling rock R or the like, the shock-absorbing embankment 45 will deform and absorb the force of impact. Further, at that time, the net body 4 will also undergo deformation due to a force of impact applied to the net body 4 by the shock-absorbing embankment 45, and thus absorb the force of impact. In this way, the force of impact is allowed to be effectively absorbed by the shock-absorbing embankment 45 and the deformable net body 4.

Here, in this embodiment, the shock-absorbing member can also be formed by piling up wood pieces and wood chips.

A guard surface structure of this embodiment comprises the guard surface 33 supported by the posts 3 serving as supporting bodies. Such guard surface 33 is deformable, and the guard surface 33 is provided with the shock-absorbing embankment 45 serving as a shock-absorbing structural body. Further, the supporting bodies are the posts 3 vertically installed at intervals, and the guard surface 33 serving as a guard surface is provided between such posts 3, 3 . . . . In this sense, same functions and effects as those of the aforementioned embodiments can be achieved with this embodiment.

Further, according to this embodiment, the shock-absorbing member is the embankment 45 serving as a structural body formed by piling up a granular substance on the mountain side of the guard surface 33. In this sense, once a force of impact has been applied, the shock-absorbing embankment 45 will deform and absorb the force of impact. Further, at that time, the guard surface 33 will also undergo deformation due to a force of impact applied thereto by the shock-absorbing embankment 45, and thus absorb the force of impact. In this way, the force of impact is allowed to be effectively absorbed by the shock-absorbing embankment 45 and the deformable guard surface 33.

Furthermore, as an effect of this embodiment, the shock-absorbing embankment 45 provided on the mountain side of the guard surface 33 is formed by filling the space between the rear and the front wall members 42, 43 with sand 41, and allowing such sand 41 to be packed therein. In this sense, this embodiment excels in shock-absorbing effectiveness, and a uniform shock absorbing effect can be achieved with this embodiment.

### Fifth Embodiment

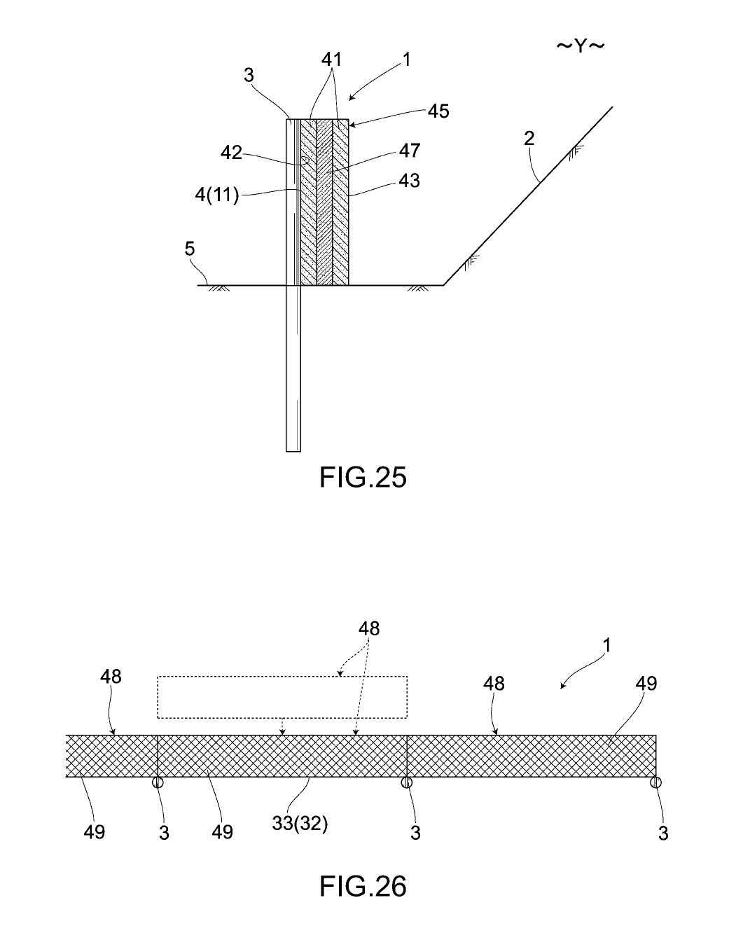

FIG. 25 shows a fifth embodiment of the present invention. Same reference numbers are used to describe the same parts as those in the aforementioned embodiments, thereby omitting the detailed descriptions of such parts when describing the fifth embodiment. According to this embodiment and with regard to the shock-absorbing embankment 45 of the fourth embodiment, a foamable synthetic resin block 47 is disposed substantially in the center of the space between the rear and front wall members 42, 43. Spaces in front of and behind the foamable synthetic resin block 47 is filled with layers of the granular substance 41, thereby allowing the foamable synthetic resin block 47 to be held therewithin, and thus forming a shock-absorbing embankment 45 having the foamable synthetic resin block 47 thereinside and serving as a shock-absorbing member. Here, styrene foam, polyethylene foam, polypropylene foam, urethane foam or the like can be employed as the foamable synthetic resin of the foamable synthetic resin block 47. Further, although this embodiment uses a plurality of the blocks 47, layers of the foamable synthetic resin can be formed via pour-in-place foaming.

Next, once the mountain side of the net body 4 has been subjected to a force of impact due to the falling rock R or the like, the shock-absorbing embankment 45 will deform and absorb the force of impact. Further, at that time, the net body 4 will also undergo deformation due to a force of impact applied thereto by the shock-absorbing embankment 45, and thus absorb the force of impact. In this way, the force of impact is allowed to be effectively absorbed by the shock-absorbing embankment 45 and the deformable net body 4. Particularly, the shock-absorbing embankment 45 comprises a front and rear layers of the granular substance 41 and the foamable synthetic resin block 46 held therebetween, thus improving the shock-absorbing effectiveness.

A guard surface structure of this embodiment comprises the net body 4 serving as a guard surface and supported by the posts 3 serving as supporting bodies. Such net body 4 is deformable, and the net body 4 is provided with wooden sticks serving as shock-absorbing members. Further, the supporting bodies are the posts 3 vertically installed at intervals, and the net body 4 serving as a guard surface is provided between such posts 3, 3 . . . . In this sense, same functions and effects as those of the aforementioned embodiments can be achieved with this embodiment.

Further, according to this embodiment, the foamable synthetic resin is used as a shock-absorbing material. In this sense, once a force of impact has been applied, the foamable synthetic resin block 47 will undergo plastic deformation and thus absorb the force of impact.

### Sixth Embodiment

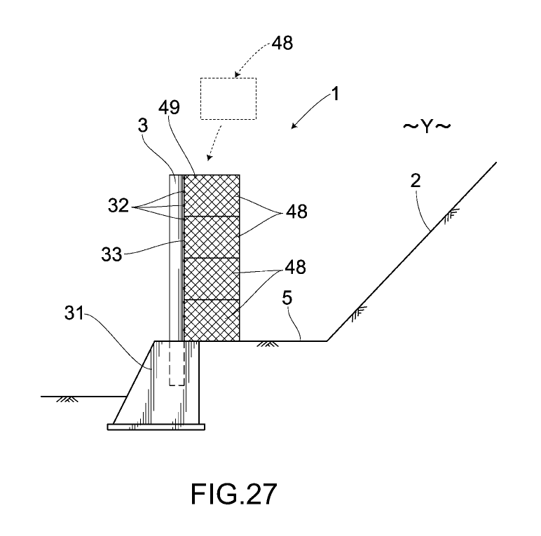

FIG. 26 and FIG. 27 show a sixth embodiment of the present invention. Same reference numbers are used to describe the same parts as those in the aforementioned embodiments, thereby omitting the detailed descriptions of such parts when describing the sixth embodiment. According to this embodiment, a gabion 48 is used as a shock-absorbing member. Such gabion 48 comprises a gabion main body 49 filled with stones such as cobbles or the like, such gabion main body 49 having an upper and an under surfaces and four side surfaces that are made of wire mesh or the like.

The gabion main body 49 is horizontally long, and has a substantially rectangular vertical cross sectional shape. Further, the gabion main body 49 has a length substantially corresponding to an interval between the posts 3, 3.

Next, a plurality of the gabions 48 are stacked up substantially to the height of the guard surface 33. An upper and a lower gabions 48, 48 are coupled to each other, and all the gabions 48, 48 are fixed to the net body 4 by means of a fixation member. Further, the gabions 48, 48 aligned next to each other in a left-right direction of the guard fence 1 are also coupled to one another in front of the posts 3.

Next, once the mountain side of the guard surface 33 has been subjected to a force of impact due to the falling rock R or the like, the gabions 48 will deform and absorb the force of impact. Further, at that time, the guard surface 33 will also undergo deformation due to a force of impact applied thereto by the gabions 48, and thus absorb the force of impact. In this way, the force of impact is allowed to be effectively absorbed by the gabions 48 filled with stones serving as granular substances and the deformable guard surface 33.

A guard surface structure of this embodiment comprises the guard surface 33 supported by the posts 3 serving as supporting bodies. Such guard surface 33 is deformable, and the net body 4 is provided with the gabions 48 serving as shock-absorbing members. Further, the supporting bodies are the posts 3 vertically installed at intervals, and the guard surface 33 is provided between such posts 3, 3 . . . . In this sense, same functions and effects as those of the aforementioned embodiments can be achieved with this embodiment.

Further, the shock-absorbing member of this embodiment is the gabion 48 comprising the gabion main body 49 filled with stones serving as granular substances, and a plurality of such gabions 48 are aligned on the mountain side of the guard surface 33. In this sense, once a force of impact has been applied, the gabions 48 will deform and thus absorb the force of impact. Further, at that time, the guard surface 33 will also undergo deformation due to a force of impact applied thereto by the gabions 48, and thus absorb the force of impact. In this way, the force of impact is allowed to be effectively absorbed by the gabions 48 and the deformable guard surface 33.

### Seventh Embodiment

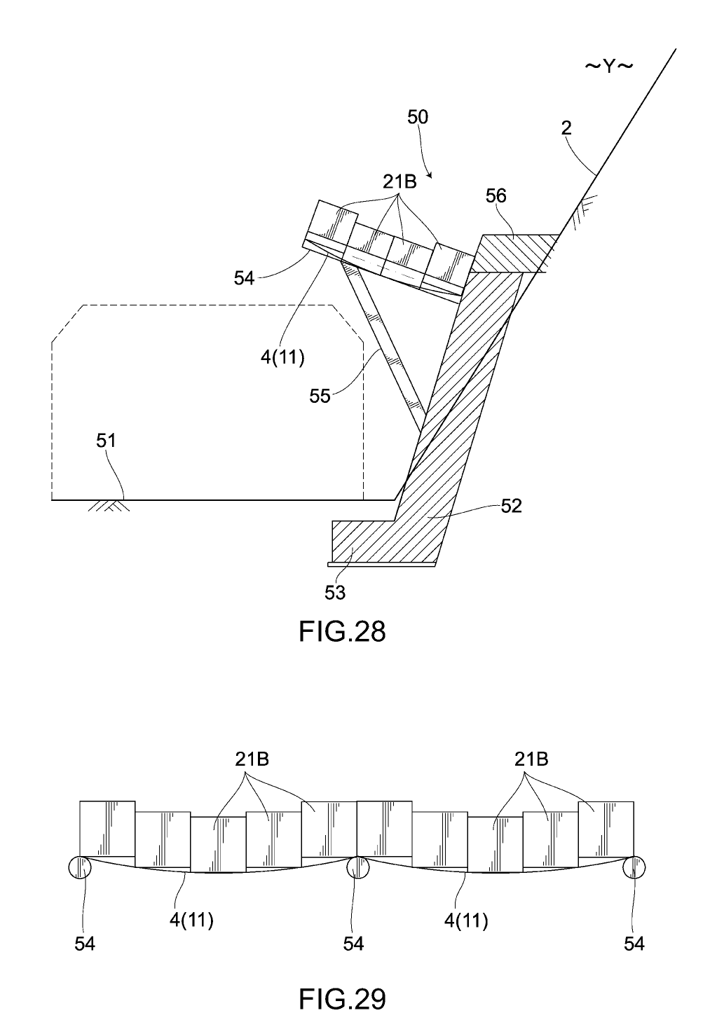

FIG. 28 and FIG. 29 show a seventh embodiment of the present invention. Same reference numbers are used to describe the same parts as those in the aforementioned embodiments, thereby omitting the detailed descriptions of such parts when describing the seventh embodiment. This embodiment shows how the present invention is applied to a guard body 50 comprising a roof for guarding roads, constructions or the like from the falling rock R, mudslide, avalanche or the like.

As shown in FIG. 28, a road 51 serving as a pathway is located beyond a lower portion of a slope 2 of a mountain, and a concrete wall structure 52 serving as a supporting body is constructed on the lower portion of the slope 2. The wall structure 52 integrally has a leg portion 53 provided on a lower portion thereof, such leg portion 53 protruding toward the road 51 and being buried thereunder.

Further, main beams 54 are provided at predetermined intervals in a longitudinal direction of the road 51. Such main beam 54 can be a steel pipe, a precast concrete beam or the like. A base end of the main beam 54 is fixed to an upper portion of the wall structure 52, while a front end thereof is a free end protruding toward the road and slanting upwardly. Furthermore, a bent 55 is used to connect the wall structure 52 and an under portion of a front end side of the main beam 54. Such bent 55 can be a steel pipe, a precast concrete beam or the like, and serves to support the front end side of the main beam 54.

Furthermore, a net body 4 comprising the wire nets 11, 11 and serving as a guard surface is stretched across the main beams 54, 54, and two sides of the wire nets 11, 11 are linked and fixed to the main beams 54 serving as components of a roof 57.

A shock-absorbing member of this embodiment is a shock-absorbing bag 21B formed by loading a cylindrical bag with a granular substance such as sand or the like. Such shock-absorbing bag 21B is formed substantially into a cuboid, particularly, a cube in this embodiment. The shock-absorbing bags 21B are so arranged on the net body 4 that there is no space left therebetween. In this case, loads of the shock-absorbing bags 21A are applied to the net body 4, thus causing the net body 4 to deflect the most in between the main beams 54, 54. In this sense, the net body 4 is caused to deflect in advance under the loads of the shock-absorbing bags 21A.

Here, according to a guard fence of the prior art (patent document 6), a predetermined amount of deflection is caused on a rope member by means of a deflection causing member. However, according to this embodiment, the wire net 11 is caused to deflect downwardly by a predetermined amount due to the weights of the shock-absorbing bags 21B, thus reducing forces applied to the main beams 54 of the guard body 50.

Further, each shock-absorbing bag 21B is fixed to the wire net 11 by means of a fixation member not shown. Such fixation member can be a fixation instrument for fixing the bag to the wire net 11, a fixing rope member wound around the bag 21B so as to fix the same, a prestitched band of the bag for linking and fixing the same to the wire net 11, or the like.

Furthermore, a shock-absorbing layer 56 is provided on the upper portion of the wall structure 52. Such shock-absorbing layer 56 can be made of a sand cushion material, a foamable synthetic resin block or the like. Here, the main beams 54, the net body and the shock-absorbing bags 21B compose the roof 57. In this case, a waterproof property can be achieved with the roof 57 when a liner sheet (not shown) is superimposed on the net body 4.

Here, there is provided between the main beams 54, 54 the deformable guard surface 50, instead of roofing materials or the like made of hard materials as there is conventionally. Here, the guard surface structure of the present invention can be disposed above a roof when applied to a roof of an existing construction to be protected. In this case, a space may be provided between an upper surface of the roof and the guard surface, thus allowing the guard surface to undergo deformation therein once subjected to a force of impact.

Next, once a force of impact due to the falling rock R or the like has been applied to an upper surface side which is the mountain side of the net body 4 serving as a guard surface, the shock-absorbing bags 21A will deform and absorb the force of impact. Further, at that time, the net body 4 will also undergo deformation due to a force of impact applied thereto by the shock-absorbing bags 21B, and thus absorb the force of impact. In this way, the force of impact is allowed to be effectively absorbed by the shock-absorbing bags 21B filled with granular substances such as sands or the like and the deformable net body 4.

A guard surface structure of this embodiment comprises the net body 4 serving as a guard surface and supported by the main beams 54 serving as supporting bodies. Such net body 4 is deformable, and is provided with shock-absorbing bags 21A filled with sand serving as a shock-absorbing material. Further, the supporting body is the guard body 50, and the net body 4 serving as a guard surface is provided between the main beams 54, 54 of the guard body 50. In this sense, same functions and effects as those of the aforementioned embodiments can be achieved with this embodiment.

Further, according to this embodiment, the shock-absorbing bags 21A serving as shock-absorbing members are placed on the net body 4 serving as a guard surface. In this sense, the wire net 11 is caused to deflect downwardly by a predetermined amount due to the weights of the shock-absorbing bags 21B, thus reducing forces applied to the main beams 54 of the guard body 50. In this case, the guard surface is preferably configured to slant by 45 degrees with respect to a vertical direction in order to cause deflection on the net body 4.

Here, the present invention is not limited to the aforementioned embodiments. As a matter of fact, various modified embodiments are possible. For example, net bodies having various shapes can be used. Further, although the deformable guard surface is preferably formed by combining steel rope members such as the wire net and the transverse rope members in the embodiments, materials of rope members can actually be appropriately chosen. Furthermore, according to the seventh embodiment, only one side (the mountain side) of the roof is supported by the supporting bodies. However, both sides of the roof (the mountain side and a side opposite to the mountain side) can be supported by supporting bodies on both sides, respectively. In addition, gabions can be disposed on the guard surface.

1. A guard surface structure comprising a guard surface supported by supporting bodies, said guard surface being deformable and provided with shock-absorbing members arranged on a mountain side thereof.

2. The guard surface structure according to claim 1, wherein said guard surface is a net body.

3. The guard surface structure according to claim 1, wherein said shock-absorbing members have granular substances.

4. The guard surface structure according to claim 2, wherein said shock-absorbing members have granular substances.

5. The guard surface structure according to claim 3, wherein said granular substances are at least one selected from a group of sands, earths and stones.

6. The guard surface structure according to claim 4, wherein said granular substances are at least one selected from a group of sands, earths and stones.

7. The guard surface structure according to claim 5, wherein said granular substances are sands such that said shock-absorbing members are shock-absorbing bags filled with the sands, and a plurality of said shock-absorbing bags are arranged on the mountain side of said guard surface.

8. The guard surface structure according to claim 6, wherein said granular substances are sands such that said shock-absorbing members are shock-absorbing bags filled with the sands, and a plurality of said shock-absorbing bags are arranged on the mountain side of said guard surface.

9. The guard surface structure according to claim 5, wherein said shock-absorbing members are structural bodies formed by piling up said granular substances on the mountain side of said guard surface.

10. The guard surface structure according to claim 6, wherein said shock-absorbing members are structural bodies formed by piling up said granular substances on the mountain side of said guard surface.

11. The guard surface structure according to claim 5, wherein said granular substances are stones such that said shock-absorbing members are gabions formed by loading gabion main bodies with the stones, and a plurality of said gabions are arranged on the mountain side of said guard surface.

12. The guard surface structure according to claim 6, wherein said granular substances are stones such that said shock-absorbing members are gabions formed by loading gabion main bodies with the stones, and a plurality of said gabions are arranged on the mountain side of said guard surface.

13. The guard surface structure according to claim 1, wherein said supporting bodies are support posts vertically installed at intervals, and said guard surface is provided between said support posts.

14. The guard surface structure according to claim 1, wherein said supporting bodies are support posts vertically installed at intervals, and said guard surface is provided between said support posts and comprises a plurality of rope members provided between said support posts.

15. The guard surface structure according to claim 1, wherein said shock-absorbing members are disposed on said guard surface.

16. The guard surface structure according to claim 2, wherein said supporting bodies are support posts vertically installed at intervals, and said guard surface is provided between said support posts.

17. The guard surface structure according to claim 3, wherein said supporting bodies are support posts vertically installed at intervals, and said guard surface is provided between said support posts.

18. The guard surface structure according to claim 4, wherein said supporting bodies are support posts vertically installed at intervals, and said guard surface is provided between said support posts.

19. The guard surface structure according to claim 2, wherein said supporting bodies are support posts vertically installed at intervals, and said guard surface is provided between said support posts and comprises a plurality of rope members provided between said support posts.

20. The guard surface structure according to claim 3, wherein said supporting bodies are support posts vertically installed at intervals, and said guard surface is provided between said support posts and comprises a plurality of rope members provided between said support posts.

21. The guard surface structure according to claim 4, wherein said supporting bodies are support posts vertically installed at intervals, and said guard surface is provided between said support posts and comprises a plurality of rope members provided between said support posts.

22. The guard surface structure according to claim 2, wherein said shock-absorbing members are disposed on said guard surface.

23. The guard surface structure according to claim 3, wherein said shock-absorbing members are disposed on said guard surface.

24. The guard surface structure according to claim 4, wherein said shock-absorbing members are disposed on said guard surface.

25. The guard surface structure according to claim 5, wherein said shock-absorbing members are disposed on said guard surface.

26. The guard surface structure according to claim 6, wherein said shock-absorbing members are disposed on said guard surface.

27. The guard surface structure according to claim 7, wherein said shock-absorbing members are disposed on said guard surface.

28. The guard surface structure according to claim 8, wherein said shock-absorbing members are disposed on said guard surface.
